(19) United States
(12) Patent Application Publication
(10) Pub. No.: US 2013/0148079 A1
(43) Pub. Date: Jun. 13, 2013

(54) SYSTEMS AND METHODS FOR POLISHING FREEFORM LENSES

(71) Applicants: Matthew John Brown, Bolton, CT (US); Steven Glenn Bedford, Ellington, CT (US)

(72) Inventors: Matthew John Brown, Bolton, CT (US); Steven Glenn Bedford, Ellington, CT (US)

(73) Assignee: Coburn Technologies, Inc., South Windsor, CT (US)

(21) Appl. No.: 13/818,947

(22) PCT Filed: Mar. 16, 2011
(86) PCT No.: PCT/US11/28625

§ 371 Date: Feb. 25, 2013

Related U.S. Application Data
(60) Provisional application No. 61/377,341, filed on Aug. 26, 2010.

(51) Int. Cl. B24B 37/26; B26D 5/00; G02C 7/02; B24B 7/24

(52) U.S. Cl. CPC B24B 37/26; B24B 7/24; B26D 5/005; G02C 7/02
USPC 351/159.67; 451/495; 451/42; 83/76.1; 83/13; 451/526; 451/532; 451/527

(57) ABSTRACT

Systems and methods for polishing a lens having a freeform design cut into a surface of the lens are provided. The system may include a lap blank having a substantial inverse of the freeform design cut into a surface of the lap blank, or a conformable lap blank having an inverse of the freeform design molded into a surface of the lap blank. The system also includes a deformable pad mounted on the surface of the lap blank. The surface of the lens is separated from the surface of the lap blank by the deformable pad, and the lens and the lap blank are arranged such that the freeform design of the surface of the lens is substantially aligned with the substantial inverse of the freeform design of the surface of the lap blank.

### CROSS-REFERENCE TO RELATED APPLICATIONS

This application is National Stage entry of PCT International Application No. PCT/US11/28625, filed on Mar. 16, 2011, which claims priority under 35 U.S.C. §119 to U.S. Provisional Patent Application No. 61/377,341, filed on Aug. 26, 2010, the contents of which are hereby incorporated by reference in their entireties.

### BACKGROUND OF THE INVENTION

The present invention relates to systems and methods for polishing freeform lenses. In contrast with standard lenses, freeform lenses may have a non-uniform cylindrical, spherical, or toric geometry. For example, a first part of a freeform lens may have a standard toric shape, while a second part of the freeform lens may include extra material that protrudes from the lens surface to increase the refractive power in the second part of the lens. In addition, a freeform lens may have a basic cylindrical, spherical, or toric shape, with an additional pattern superimposed on the basic shape. A highly complex pattern may be cut into a surface of the lens. For example, freeform lenses may be used in progressive eyeglasses that can be customized for the individual wearer. Some exemplary freeform lenses are disclosed in U.S. Pat. No. 6,019,470 to Mukaiyama et al., the disclosure of which is incorporated by reference in its entirety into the present application.

Specialized freeform lens polishing systems have been developed to polish freeform lenses having a freeform design cut into a surface of the lens. These freeform lens polishing systems are typically large, complicated, and expensive machines. For example, a freeform lens polishing system may use a small mushroom-shaped tool to polish the surface having the freeform design. As the tool spins and polish is applied between the tool and the freeform surface, the lens is pushed against the spinning tool and moved in a controlled pattern. A computer may be programmed to move the lens in a complex and non-uniform pattern against the spinning tool. This allows the freeform lens polishing system to account for the non-uniform geometry of the freeform surface of the lens.

In contrast, cylinder lens polishing systems are smaller, simpler, and less expensive than freeform polishing systems. Cylinder lens polishing systems typically perform the same mechanical motion for a variety of lenses, and do not need a computer to control the motion of the lens during polishing. However, as explained in detail below, cylinder lens polishing systems do not achieve satisfactory results for polishing freeform lenses, because the polished surface of the freeform lens is damaged by non-uniform pressure on the lens during polishing. This causes unacceptable distortions of the polished freeform lens surface.

Therefore, it would be advantageous to develop a system for polishing freeform lenses that uses cylinder lens polishing systems instead of freeform lens polishing systems. In particular, a system is needed to overcome the problem of damage to the polished surface of the freeform lens encountered when polishing freeform lenses with cylinder lens polishing systems.

### SUMMARY OF THE INVENTION

Systems and methods consistent with the present invention use cylinder lens polishing systems to polish freeform lenses. According to an aspect of the invention, a system is provided for polishing a lens having a freeform design cut into a surface of the lens. The system may include a lap blank having a substantial inverse of the freeform design cut into a surface of the lap blank. Alternatively, the system may include a conformable lap blank having a substantial inverse of the freeform design molded into a surface of the lap blank. The system also includes a deformable pad mounted on the surface of the lap blank. The surface of the lens is separated from the surface of the lap blank by the deformable pad, and the lens and the lap blank are arranged such that the freeform design of the surface of the lens is substantially aligned with the substantial inverse of the freeform design of the surface of the lap blank.

The deformable pad may include a deformable foam rubber layer. The deformable pad may also include a felt layer that is arranged between the deformable foam rubber layer and the surface of the lens. The deformable pad may have a disc-like cross-sectional shape or a flower-like cross-sectional shape.

The freeform design may have a non-uniform cylindrical, spherical, or toric geometry. Alternatively, the freeform design may include a pattern superimposed on a cylindrical, spherical, or toric shape. The deformable pad may be affixed to the surface of the lap blank by an adhesive.

According to another aspect of the invention, a method is provided for polishing a lens having a freeform design cut into a surface of the lens. The method includes forming a substantial inverse of the freeform design in a surface of a lap blank; mounting a deformable pad on the surface of the lap blank; arranging the lens and the lap blank such that the freeform design of the surface of the lens is substantially aligned with the substantial inverse of the freeform design of the surface of the lap blank; mounting the lap blank, the deformable pad, and the lens in a cylinder lens polishing machine such that the surface of the lens is separated from the surface of the lap blank by the deformable pad; and polishing the lens by moving the deformable pad in an oscillating motion with respect to the lens, while the lens is pushed against the deformable pad.

According to the method, the substantial inverse of the freeform design may be cut into the surface of the lap blank. Alternatively, the lap blank may be a conformable lap blank, and the substantial inverse of the freeform design may be molded into the surface of the lap blank. The method may also include applying a polish slurry between the lens and the lap blank.

According to yet another aspect of the invention, a surfacing machine is provided for cutting a substantial inverse of a freeform design into a surface of a lap blank. The surfacing machine includes a processor that inverts data representing the freeform design, and a cutting tool that cuts the substantial inverse of the freeform design into the surface of the lap blank.

According to still another aspect of the invention, a deformable pad is provided for polishing a lens having a freeform design cut into a surface of the lens. The deformable pad includes a deformable foam rubber layer that deforms to provide a substantially uniform pressure across the surface of the lens during polishing. The deformable pad may also include a felt layer that is configured to be arranged between the deformable foam rubber layer and the surface of the lens during polishing. The deformable pad may have a disk-like cross-sectional shape or a flower-like cross-sectional shape.

Other objects, advantages, and novel features of the present invention will become apparent from the following detailed description of the invention when considered in conjunction with the accompanying drawings.

### BRIEF DESCRIPTION OF THE DRAWINGS

FIG. 1 shows a lap blank according to an exemplary embodiment of the invention;

FIG. 2 shows a surfacing machine that cuts a substantial inverse of a freeform design into a surface of a lap blank according to an exemplary embodiment of the invention;

FIGS. 3A-3C show views of a deformable pad according to an exemplary embodiment of the invention;

FIGS. 4A-4B show exemplary embodiments in which the deformable pad is mounted on the lap blank;

FIG. 5 shows an exemplary embodiment in which the lap blank and the deformable pad are mounted in a cylinder lens polishing machine to polish a freeform surface of a lens; and

FIG. 6 shows a conformable lap blank according to an exemplary embodiment of the invention.

### DETAILED DESCRIPTION OF EXEMPLARY EMBODIMENTS

Exemplary cylinder lens polishing systems are described in U.S. Pat. Nos. 3,732,647 to Stith, 4,320,599 to Hill et al., and 4,521,994 to Tusinski, the disclosures of which are incorporated by reference in their entireties into the present application. As discussed above, these cylinder lens polishing systems are designed to polish standard cylindrical, spherical, or toric lens surfaces. The Stith patent discloses a cylinder lens polishing system in which lenses are polished by being biased into engagement with a lapping tool having a spherical or toric surface of a final desired prescription. The lapping tool is driven in an orbital break-up motion relative to the lens to prevent ridges, grooves, and/or other aberrations from forming in the lens surface that might occur if regular or uniform motion devices were utilized. In addition to orbital break-up motion of the lapping tool, the Stith patent discloses moving the lens in a transverse motion from side-to-side.

In the cylinder lens polishing system described in the Hill et al. patent, first and second assemblies are provided for carrying a lapping tool and lens, respectively, imparting the orbital break-up motion during the lens polishing operation. The amplitude of the orbital motion is made variable by applying a cam assembly to adjust the degree of the orbital break-up motion of the lens mounting and/or the lapping tool.

The Tusinski patent discloses a cylinder lens polishing system with a frame and gimbal mounted assembly for providing the orbital break-up motion to the lens lapping tool. An X-Y motion assembly is connected to the frame and the lens for providing smooth Lissajous figure motions to the lens. The X-Y motion assembly is reciprocally driven by a first cam that drives the lens in an X direction and a second cam that simultaneously drives the lens in a Y direction. The first and second cams are commonly driven, and the amplitude of the X and Y motion and the relative frequency may be selectively varied by the mechanical drive system. Lens polishing is achieved by providing the orbital break-up motion with the lapping tool and a simultaneous X-Y motion of the lens biased against an upper surface of the lapping tool.

As discussed above, these cylinder lens polishing systems do not achieve satisfactory results for polishing freeform lenses having a freeform design cut into a surface of the lens, because the freeform surface of the lens is damaged by non-uniform pressure on the surface during polishing. For example, a freeform surface may include a feature that substantially protrudes from a toric portion of the surface. This feature may be added to provide additional refractive power at a particular location desired by a user. When the hard lapping tool encounters this feature, more pressure is applied to this feature than the underlying toric portion of the surface. This causes more material to be removed from the feature than from the underlying toric portion of the surface during polishing. Accordingly, the desired feature is at least partially removed from the freeform surface by the hard lapping tool. In general, the non-uniform pressure produced by the hard lapping tool of the cylinder lens polishing system causes more material to be removed from the freeform surface at higher pressure points than at lower pressure points, which results in optical distortions in the freeform surface of the lens.

To address this problem, exemplary embodiments of the present invention cut a substantial inverse of the same freeform design into a surface of a lap blank, and insert a deformable pad between the substantial inverse surface of the lap blank and the freeform surface of the lens while the lens is being polished. For example, the deformable pad may be a thick foam rubber pad that deforms to allow motion between the freeform lens and the lap blank without creating localized pressure points. By using this arrangement, a substantially constant force is transmitted into the lens during polishing, thereby avoiding damage to the freeform surface of the lens.

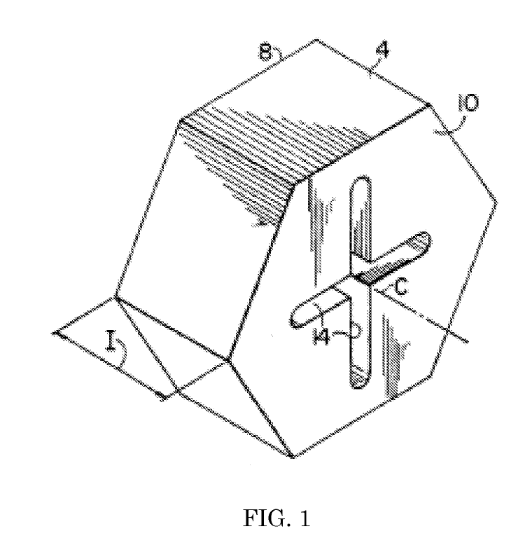

FIG. 1 shows an exemplary lap blank 4 as disclosed in U.S. Pat. No. 5,269,102 to Wood, the disclosure of which is incorporated by reference in its entirety into the present application. The lap blank 4 is capable of being custom cut by a surfacing machine to create a substantial inverse of the freeform design cut into the surface of the lens to be polished. Referring to FIG. 1, the lap blank 4 is a block of material that is readily cutable by the surfacing machine, yet is sufficiently strong to support a lens blank and block assembly during polishing of the lens. One non-limiting example of a material suitable for this purpose is foamed polystyrene, which is commercially available in extruded form. In the illustrated embodiment, the lap blank 4 has a first side face 8 and an opposite second side face 10 that are separated by a thickness I, which may be approximately 1.25 inches. The lap 4 may have various shapes, but the illustrated embodiment has a six-sided parallelogram configuration with opposite sides thereof measuring across about 3.0 inches.

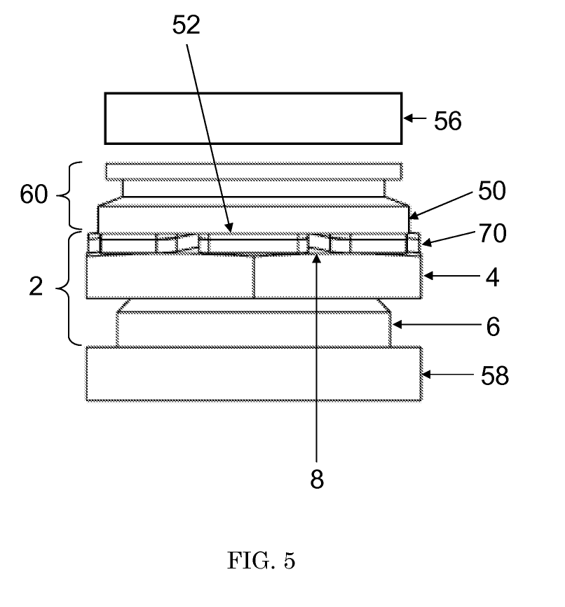

As shown in FIG. 1, the second side face 10 of the lap blank 4 includes a cross-shaped configuration 14 for engaging with a lap holder 6 (shown in FIG. 5). In the illustrated embodiment, the cross-shaped configuration 14 includes two slot-like blind recesses extending into the lap blank 4, the intersection thereof being coincident with the geometric center C of the lap blank 4.

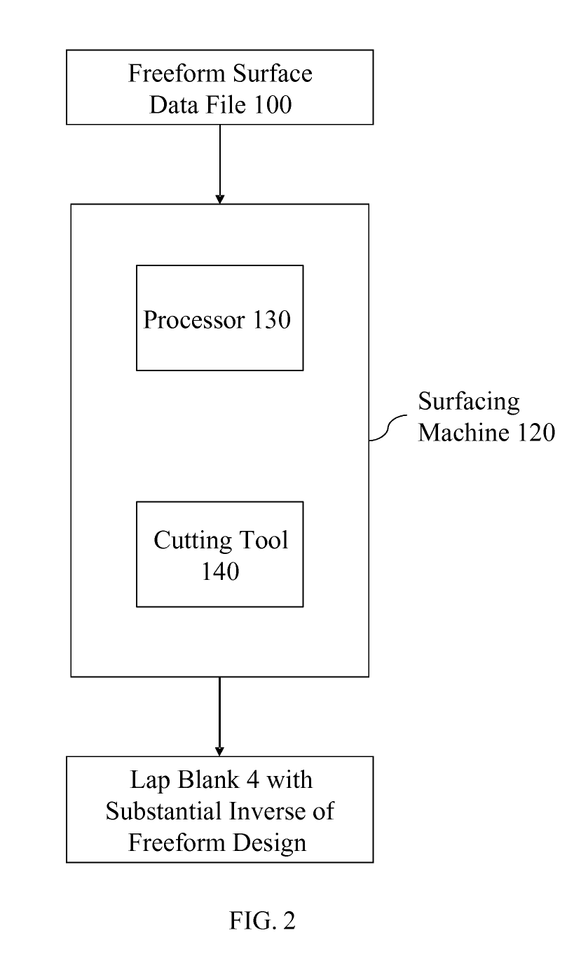

FIG. 2 shows a surfacing machine 120 that cuts the first side face 8 of the lap blank 4 to create a substantial inverse of the freeform design previously cut into the surface of the lens to be polished. An example of the surfacing machine 120 is described in U.S. Pat. No. 5,485,771 to Brennan et al., the disclosure of which is incorporated by reference in its entirety into the present application. The surfacing machine 120 includes a mechanism for rotating the lap blank 4 about an axis of rotation, and a cutting tool 140 for imparting the substantial inverse of the freeform design onto the rotating lap blank 4.

As used throughout this application, the term “substantial inverse” may include an exact inverse of the freeform design previously cut into the lens to be polished, or an approximation of the inverse of the freeform design. For example, the substantial inverse may be a smoothed-out version of the inverse of the freeform design, or any other suitable modification of the inverse of the freeform design. The features of the inverse of the freeform design are complementary to the features of the freeform design. For example, a bump on the inverse of the freeform design lines up with a correspondingly shaped recess on the freeform design. Similarly, a near vision prescription power formed on the lens as additional material lines up with a correspondingly shaped inverse feature on the lap blank 4.

As shown in FIG. 2, the surfacing machine 120 receives a freeform surface data file 100 that includes data defining the freeform design cut into the surface of the lens to be polished. The freeform surface data file 100 may be provided to the surfacing machine 120 by any appropriate means. One non-limiting example is a computer-readable medium, such as a floppy disk, a flexible disk, a hard disk, magnetic tape, any other magnetic medium, a CD-ROM, a DVD-ROM, any other optical medium, punch cards, paper tape, any other physical medium with patterns of holes, a RAM, a PROM, an EPROM, a FLASH-EPROM, a flash drive, or any other memory chip or cartridge. Another non-limiting example is transmission via coaxial cables, copper wire, fiber optics, or an Internet connection.

Once the freeform surface data file 100 has been obtained by the surfacing machine 120, a processor 130 within the surfacing machine 120 inverts the data defining the freeform design cut into the surface of the lens to be polished. The cutting tool 140 then uses the inverted data to cut the substantial inverse of the freeform design into the first side face 8 of the lap blank 4.

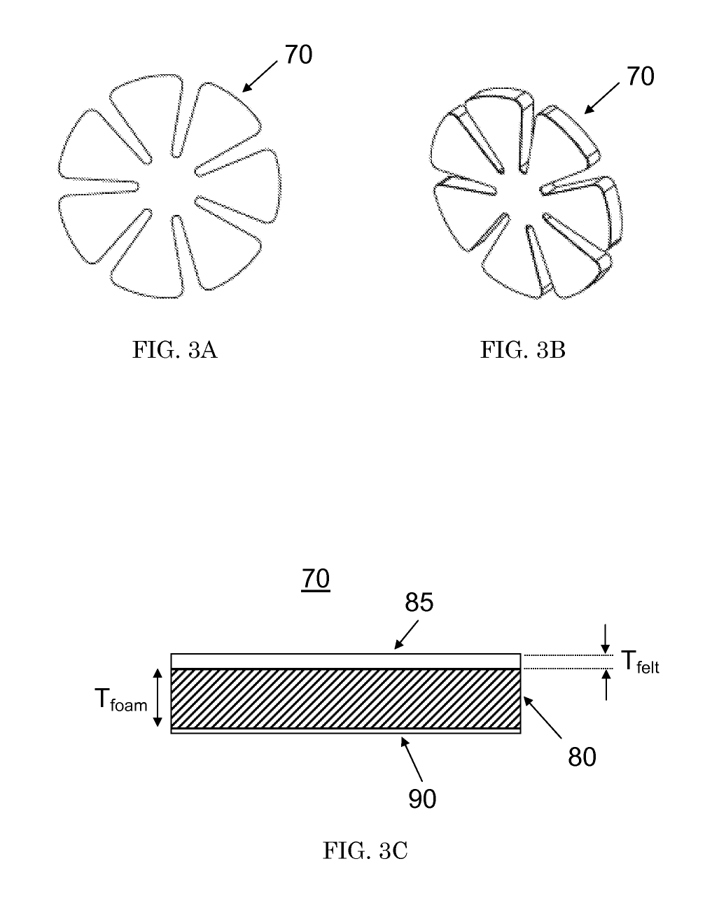

FIGS. 3A-3C show views of an exemplary embodiment of the deformable pad 70. FIG. 3A is a plan view of the deformable pad 70, FIG. 3B is a perspective view of the deformable pad 70, and FIG. 3C is a side view of the deformable pad 70. As shown in FIG. 3C, the deformable pad 70 may include a deformable foam rubber layer 80 with a thickness T_{foam} of approximately 0.25″. As a non-limiting example, the deformable foam rubber layer 80 may be made of an ether-based open cell urethane foam such as HyPUR-cel® #T-1505 by Rubberlite®, which has a density of approximately 15 lb/ft³ and a compression deflection of approximately 5 PSI at 25% compression. Any other suitable material that provides a substantially constant force displacement to the lens during polishing may be used as the deformable foam rubber layer 80.

The deformable pad 70 may also include a felt pad 85 with a thickness Tfelt of approximately 0.015″. Other suitable dimensions may be used. The deformable pad 70 may have the flower-like shape shown in FIGS. 3A and 3B or any other suitable shape, such as a disk or a variant of a disk.

Alternatively, the felt pad 85 may be provided as a separate component that is placed on top of the deformable foam rubber layer 80. The felt pad 85 may be used as a finishing pad during polishing. In addition, the deformable pad 70 may include an adhesive layer 90, which can be used to affix the deformable pad 70 to the lap blank 4. The thicknesses of the layers of the deformable pad 70 shown in FIG. 3C are exaggerated for clarity, and are not drawn to scale.

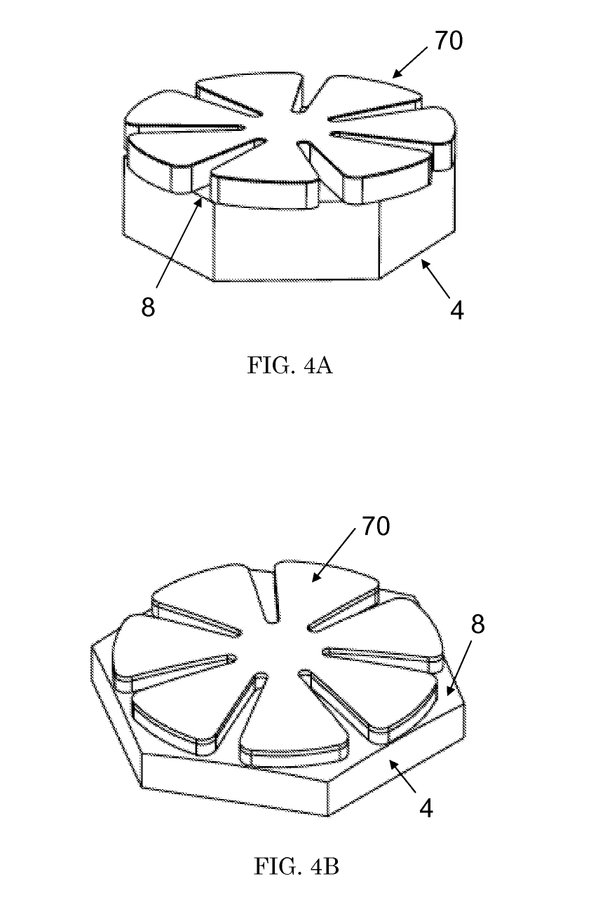

FIG. 4A shows an exemplary embodiment in which the deformable pad 70 is mounted on the lap blank 4. In FIG. 4A the lap blank 4 is shown as having a planar first side surface 8. FIG. 4B shows another exemplary embodiment in which the deformable pad 70 is mounted on the lap blank 4. In FIG. 4B the first side surface 8 of the lap blank 4 has been cut to have a substantial inverse of the freeform design that was cut into the surface 52 of the lens 50 to be polished.

FIG. 5 shows an exemplary embodiment in which a lap blank and holder assembly 2 is mounted in a cylinder lens polishing machine to polish the freeform surface 52 of the lens 50. Here the lap blank 4 is shown after a substantial inverse of the freeform design of the surface 52 of the lens 50 has been cut into the first side face 8 of the lap blank 4. The lens 50 and the lap blank 4 are arranged such that the freeform design of the surface 52 of the lens 50 is substantially aligned with the substantial inverse of the freeform design of the first side face 8 of the lap blank 4.

A deformable pad 70 is arranged between the respective freeform surfaces of the lap blank 4 and the lens 50. When the deformable pad 70 and the lens 50 are pressed together, the top surface of the deformable pad 70 conforms to the freeform design in the adjacent freeform surface 52 of the lens 50. Similarly, when the deformable pad 70 and the lap blank 4 are pressed together, the bottom surface of the deformable pad 70 conforms to the adjacent substantially inverse freeform surface cut into the first side face 8 of the lap blank 4. The deformable pad 70 may be affixed to the lap blank 4 by the adhesive layer 90.

The lens 50 is then polished to improve its optical clarity. In order to polish the surface 52 of the lens 50, the lens blank and block assembly 60 is stacked with the lap blank and holder assembly 2 in a cylinder lens polishing system. The two assemblies are clamped with one another between the upper arm 56 and the lower arm 58 of the cylinder lens polishing system. The holder 6 may be clamped to the lower arm 58, while the lens blank assembly 60 may be secured to the upper arm 56. This permits the relative oscillating movement between the lens 50 and the lap blank 4.

During polishing, a very small amount of material is removed very uniformly from the freeform surface 52 of the lens 50. For example, the deformable pad 70 may be moved in a rotate/orbit motion while the lens 50 is pushed down on the deformable pad 70. During polishing, a polish slurry is sprayed between the lens 50 and the lap blank 4. The slurry contains very small particles and removes small amounts of material from the freeform surface 52 of the lens 50. Because the aligned freeform designs in the lens 50 and the lap blank 4 are separated by the deformable pad 70, a substantially uniform pressure is advantageously applied across the freeform surface 52 of the lens 50. This enables a cylinder lens polishing machine to polish the freeform lens 50 without causing damage to the freeform surface 52.

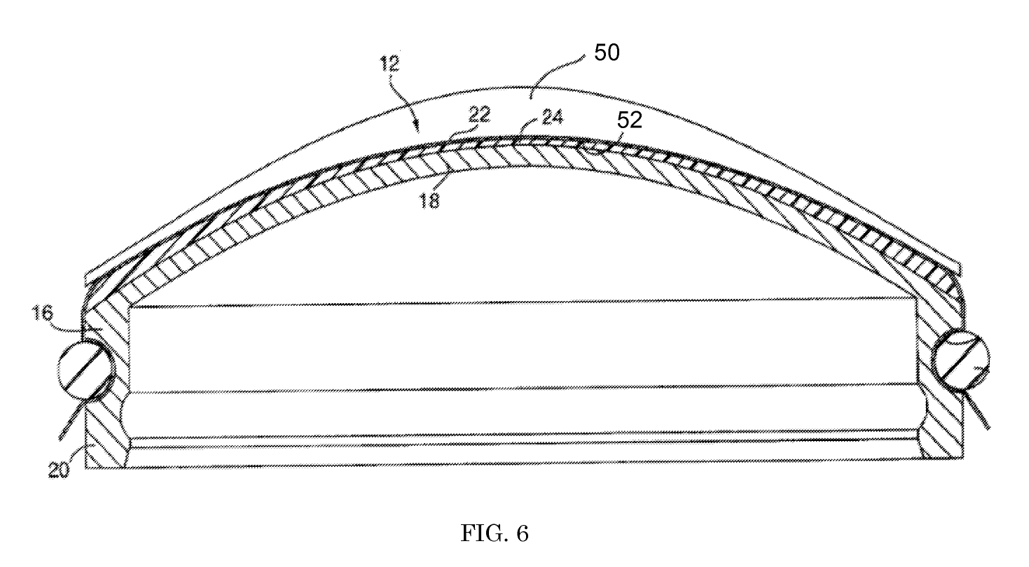

As an alternative embodiment, the deformable pad 70 may be used in conjunction with a conformable lap blank. An exemplary conformable lap blank is disclosed in U.S. Pat. No. 6,527,632 to Dooley et al., the disclosure of which is incorporated by reference in its entirety into the present application. In general, a conformable lap blank has a work surface that is adapted to conform to the curvature of the surface of the lens to be polished. For example, FIG. 6 shows a conformable lap blank 12 that includes a base 16 with a rigid base surface 18 and a mounting flange 20. A work surface 22 is superimposed over the rigid base surface 18, and a layer of a conformable substance 24 is arranged between the work surface 22 and the rigid base surface 18. The conformable substance 24 can be changed between solid and non-solid forms by applying or withdrawing heat.

To mold the work surface 22 of the conformable lap blank 12 into a substantial inverse of the shape of the freeform design that was cut into the surface 52 of the lens 50 to be polished, the conformable substance 24 is first heated to change into its non-solid form. While the conformable substance 24 is in its non-solid form, the work surface 22 is conformed to match the freeform surface 52 of the lens 50 by pressing the freeform surface 52 of the lens 50 against the work surface 22. The conformable substance 24 is then cooled to return to its solid form. Next, the deformable pad 70 is mounted on the work surface 22 of the conformable lap blank 12, which is mounted in the cylinder lens polishing machine in place of the lap blank 4 shown in FIG. 5. The lens 50 is then polished as described above with reference to FIG. 5. Again, because the pressure between the lens 50 and the conformable lap blank 12 causes the respective surfaces of the deformable pad 70 to conform to the respective freeform designs, a substantially uniform pressure is applied across the freeform surface 52 of the lens 50 during polishing.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A system for polishing a lens having a freeform design cut into a surface of the lens, the system comprising:
a lap blank having a substantial inverse of the freeform design cut into a surface of the lap blank; and
a deformable pad mounted on the surface of the lap blank, wherein:
the surface of the lens is separated from the surface of the lap blank by the deformable pad, and
the lens and the lap blank are arranged such that the freeform design of the surface of the lens is substantially aligned with the substantial inverse of the freeform design of the surface of the lap blank.

2. The system recited in claim 1, wherein the deformable pad comprises a deformable foam rubber layer.

3. The system recited in claim 2, wherein the deformable pad further comprises a felt layer that is arranged between the deformable foam rubber layer and the surface of the lens.

4. The system recited in claim 2, wherein the deformable pad has a disk-like cross-sectional shape.

5. The system recited in claim 2, wherein the deformable pad has a flower-like cross-sectional shape.

6. The system recited in claim 1, wherein the freeform design has a modified cylindrical, spherical, or toric geometry.

7. The system recited in claim 1, wherein the freeform design comprises a pattern superimposed on a cylindrical, spherical, or toric shape.

8. The system recited in claim 1, wherein the deformable pad is affixed to the surface of the lap blank by an adhesive.

9. A system for polishing a lens having a freeform design cut into a surface of the lens, the system comprising:
a conformable lap blank having a substantial inverse of the freeform design molded into a surface of the lap blank; and
a deformable pad mounted on the surface of the lap blank, wherein:
the surface of the lens is separated from the surface of the lap blank by the deformable pad, and
the lens and the lap blank are arranged such that the freeform design of the surface of the lens is substantially aligned with the substantial inverse of the freeform design of the surface of the lap blank.

10. The system recited in claim 9, wherein the deformable pad comprises a deformable foam rubber layer.

11. The system recited in claim 10, wherein the deformable pad further comprises a felt layer that is arranged between the deformable foam rubber layer and the surface of the lens.

12. The system recited in claim 10, wherein the deformable pad has a disk-like cross-sectional shape.

13. The system recited in claim 10, wherein the deformable pad has a flower-like cross-sectional shape.

14. The system recited in claim 10, wherein the freeform design has a modified cylindrical, spherical, or toric geometry.

15. The system recited in claim 9, wherein the freeform design comprises a pattern superimposed on a cylindrical, spherical, or toric shape.

16. The system recited in claim 9, wherein the deformable pad is affixed to the surface of the lap blank by an adhesive.

17. A method for polishing a lens having a freeform design cut into a surface of the lens, the method comprising:
forming a substantial inverse of the freeform design in a surface of a lap blank;
mounting a deformable pad on the surface of the lap blank;
arranging the lens and the lap blank such that the freeform design of the surface of the lens is substantially aligned with the substantial inverse of the freeform design of the surface of the lap blank;
mounting the lap blank, the deformable pad, and the lens in a cylinder lens polishing machine such that the surface of the lens is separated from the surface of the lap blank by the deformable pad; and
polishing the lens by moving the deformable pad in an oscillating motion with respect to the lens, while the lens is pushed against the deformable pad.

18. The method recited in claim 17, wherein the substantial inverse of the freeform design is cut into the surface of the lap blank.

19. The method recited in claim 17, wherein the substantial inverse of the freeform design is molded into the surface of the lap blank, and the lap blank is a conformable lap blank.

20. The method recited in claim 17, further comprising applying a polish slurry between the lens and the lap blank.

21. The method recited in claim 17, wherein the deformable pad comprises a deformable foam rubber layer.

22. The method recited in claim 21, wherein the deformable pad further comprises a felt layer that is arranged between the deformable foam rubber layer and the surface of the lens.

23. The method recited in claim 17, wherein the freeform design has a modified cylindrical, spherical, or toric geometry.

24. The method recited in claim 17, wherein the freeform design comprises a pattern superimposed on a cylindrical, spherical, or toric shape.

25. A freeform lens polished according to the method recited in claim 17.

26. A pair of eyeglasses comprising at least one freeform lens polished according to the method recited in claim 17.

27. A surfacing machine for cutting a substantial inverse of a freeform design into a surface of a lap blank, the surfacing machine comprising:
a processor that inverts data representing the freeform design; and
a cutting tool that cuts the substantial inverse of the freeform design into the surface of the lap blank.

28. A method for cutting a substantial inverse of a freeform design into a surface of a lap blank, the method comprising:
inverting data representing the freeform design; and
cutting the substantial inverse of the freeform design into the surface of the lap blank.

29. A deformable pad for polishing a lens having a freeform design cut into a surface of the lens, the deformable pad comprising:
a deformable foam rubber layer that deforms to provide a substantially uniform pressure across the surface of the lens during polishing.

30. The deformable pad recited in claim 29, further comprising a felt layer that is configured to be arranged between the deformable foam rubber layer and the surface of the lens during polishing.

31. The deformable pad recited in claim 29, wherein the deformable pad has a disk-like cross-sectional shape.

32. The deformable pad recited in claim 29, wherein the deformable pad has a flower-like cross-sectional shape.
